(19) United States
(12) Patent Application Publication
(10) Pub. No.: US 2008/0037055 A1
(43) Pub. Date: Feb. 14, 2008

(54) IMAGE FORMING DEVICE AND METHOD OF ADJUSTING DATA TRANSMISSION RATE

(75) Inventor: Eun-kyung YUN, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/679,213

(22) Filed: Feb. 27, 2007

(30) Foreign Application Priority Data
Aug. 11, 2006 (KR) 2006-76128

(51) Int. Cl. H04N 1/00; H04L 12/26

(52) U.S. Cl. 358/1.15; 370/232

(57) ABSTRACT

An image forming device and method to adjust a data transmission rate includes a data transmitter to transmit scanned image data to a server, and a controller to operate the data transmitter to adjust the transmission rate of the image data corresponding to the server.

### CROSS-REFERENCE TO RELATED APPLICATIONS

This application claims priority under 35 U.S.C. § 119(a) of Korean Patent Application No. 10-2006-0076128, filed in the Korean Intellectual Property Office on Aug. 11, 2006, the entire disclosure of which is incorporated herein by reference.

### BACKGROUND OF THE INVENTION

1. Field of the Invention

The present general inventive concept relates to an image forming device and a method which are capable of adjusting data transmission rate. More particularly, the present general inventive concept relates to an image forming device which can stably transmit scanned data to a server in the network by adjusting a transmission time between data packets and consequently adjusting a data transmission rate of the entire data, and a method of adjusting the data transmission rate.

2. Description of the Related Art

Image forming devices are devices which copy films, photos, documents, drawings and so on, optically scan and measure the intensity of reflected light and transmitted light, and perform analog-to-digital (AD) conversion. Such image forming devices include scanners and multi function peripherals (MFP) with a scanning function.

Recently, network systems which connect an image forming device to a plurality of servers using a network for use by large numbers of people have become widespread not only in offices, but also in private homes. In such network systems, the image forming device transmits scanned films, photos, documents and drawings to a server to store or edit.

When transmitting the scanned image data to the server, if the rate of transmitting the image data is higher than the rate of receiving and processing the image data in the server, a time-out error occurs. To solve this problem, the server's time-out could be increased. However, when transmitting data, the server's time-out has to be set, causing inconvenience to the user. Additionally, even if errors occur continually in transmitting image data, the image forming device does not provide any information on the data transmission errors, so a user may experience the same problem as described above.

### SUMMARY OF THE INVENTION

The present general inventive concept provides an image forming device which can stably transmit an image data to a server in the network by adjusting a transmission time between data packets and consequently adjusting the data transmission rate of the entire data, and a method for adjusting the data transmission rate.

The present general inventive concept provides an image forming device which stores a list of servers having an error occurrence history, reduces a data transmission error by managing the corresponding servers when transmitting next data, and displays information on the data transmission error to show to the user, and a method of adjusting the data transmission rate.

Additional objects and aspects of the present general inventive concept will be set forth in part in the description which follows and, in part, will be obvious from the description, or may be learned by practice of the general inventive concept.

The foregoing and/or other aspects of the present general inventive concept may also be achieved by providing an image forming device which scans a document, the image forming device including a data transmitter which transmits a scanned image data to a server, and a controller which operates the data transmitter to adjust a transmission rate of the image data corresponding to the server.

The image forming device may further include a storage unit which stores a list of servers having a history of data transmission errors, wherein the controller confirms whether the server to which the image data is transmitted is included in the list, the controller adjusts the transmission rate of the image data if the server is included in the list, and the controller operates the data transmitter to transmit the image data at a preset transmission rate if the server is not included in the list.

The image forming device may further include a user interface to adjust the transmission rate of the data, wherein if the server is included in the list, the controller operates the data transmitter to transmit the image data at a transmission rate adjusted by the user interface.

The image forming device may further include a message generator which generates a message to report that the server is included in the list, if the server is included in the list; and a display which displays the message.

If the server is included in the list, the controller operates the message generator and the display to generate and display a message including the preset transmission rate, an optimal transmission rate for the server, and minimum and maximum transmission rates that can be input.

If a data transmission error occurs when transmitting the image data at the preset transmission rate, the controller operates the message generator and the display to generate and display a message reporting the error occurrence, and also operates the storage to add the server to the list.

The data transmitter may transmit the image data using one of Hypertext Transfer Protocol (HTTP), File Transfer Protocol (FTP), Server Message Block (SMB), Secure Hypertext Transfer Protocol (HTTPS) and Simple Mail Transfer Protocol (SMTP).

The server to which the image data is transmitted may be at least one server among a plurality of servers connected to the network.

The foregoing and/or other aspects of the present general inventive concept may also be achieved by providing a data transmission method of an image forming device which scans a document, the method including scanning a document and generating image data, and transmitting the image data by adjusting a transmission rate of the image data corresponding to a server to which the image data is transmitted.

The transmitting of the image data further includes confirming whether the server is included in a list of servers having a history of data transmission errors, and adjusting the transmission rate of the image data if the server is included in the list, and transmitting the image data at a preset transmission rate if the server is not included in the list.

The method may further include generating and displaying a message reporting the error occurrence if a data transmission error occurs when transmitting the image data at the preset transmission rate.

The method further may include adding the server to the list, if a data transmission error occurs when transmitting the image data at the preset transmission rate.

The transmitting of the image data may include providing a user interface to adjust the transmission rate of the image data if the server is included in the list; and transmitting the image data at a transmission rate adjusted through the user interface.

The user interface may display the preset transmission rate, an optimal transmission rate for the server, and minimum and maximum transmission rates to be input.

A message reporting that the server is included in the list is generated and displayed if the server is included in the list.

The image data may be transmitted using one of Hypertext Transfer Protocol (HTTP), File Transfer Protocol (FTP), Server Message Block (SMB), Secure Hypertext Transfer Protocol (HTTPS) and Simple Mail Transfer Protocol (SMTP).

The server to which the image data is transmitted is at least one server among a plurality of servers connected to the network.

The foregoing and/or other aspects of the present general inventive concept may also be achieved by providing an image forming device which scans a document, the image forming device including: a data transmitter which transmits a scanned image data to a server, a storage unit which stores a list of servers having a history of data transmission errors; and a controller which operates the data transmitter to adjust the transmission rate of the image data corresponding to the server if the server is included in the list.

The image forming device may further include a display, a message generator which generates a message to be shown on the display; and a user interface which adjusts the transmission rate of the image data, wherein if the server is included in the list, the controller operates the message generator and the display to generate and display a message reporting the possibility of the occurrence of a data transmission error when transmitting the image data, and operates the data transmitter to transmit the image data at the transmission rate adjusted by the user interface.

The foregoing and/or other aspects of the present general inventive concept may also be achieved by providing an image forming device to scan a document, the device including storage unit to store a list of servers having a history of one or more data transmission errors, and a controller to adjust a transmission rate of the image data according to a selected server if the selected server is included in the list.

The foregoing and/or other aspects of the present general inventive concept may also be achieved by providing an image forming device including a data transmitter to transmit image data to a selected server, and a controller to adjust a transmission rate according to a history of occurrence of one or more data transmission error of the selected server.

The foregoing and/or other aspects of the present general inventive concept may also be achieved by providing an image forming device including a storage unit to store information on a data transmission error of a server, and a data transmitter to transmit data at a transmission rate to another server, and to transmit the data at an adjusted transmission rate to the server according to the information.

The foregoing and/or other aspects of the present general inventive concept may also be achieved by providing an image forming device including a storage unit to store information on a data transmission error of a server, and a data transmitter to transmit a first packet of data to the server at a first adjusted transmission rate and a second packet of the data at a second adjusted transmission rate to the server according to the information.

The foregoing and/or other aspects of the present general inventive concept may also be achieved by providing a method of transmitting data at a data transmission rate to a server having a maximum data acceptance rate in a data transmission system, the method including storing a list of error-prone servers in a storage unit, and adjusting a data transmission rate of scanned image data to be sent a server if the server is on the list.

The foregoing and/or other aspects of the present general inventive concept may also be achieved by providing a computer readable recording medium containing computer readable codes as a program to execute a method of transmitting data to a server, the method including scanning a document and generating image data, and transmitting the image data to a server by adjusting a transmission rate of the image data corresponding to the server to which the image data is transmitted.

### BRIEF DESCRIPTION OF THE DRAWINGS

These and/or other objects and aspects of the present general inventive concept will become apparent and more readily appreciated from the following description of the embodiments, taken in conjunction with the accompanying drawings of which:

FIG. 1 illustrates a configuration of a data transmission system according to an embodiment of the general inventive concept;

FIG. 2 is a block diagram illustrates an image forming device according to an exemplary embodiment of the present invention;

FIG. 3A and FIG. 3B exemplify message windows regarding data transmission;

FIG. 4 illustrates a window for adjusting the data transmission rate; and

FIG. 5 is a flow chart illustrating a data transmission method of an image forming device according to an embodiment of the present General inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

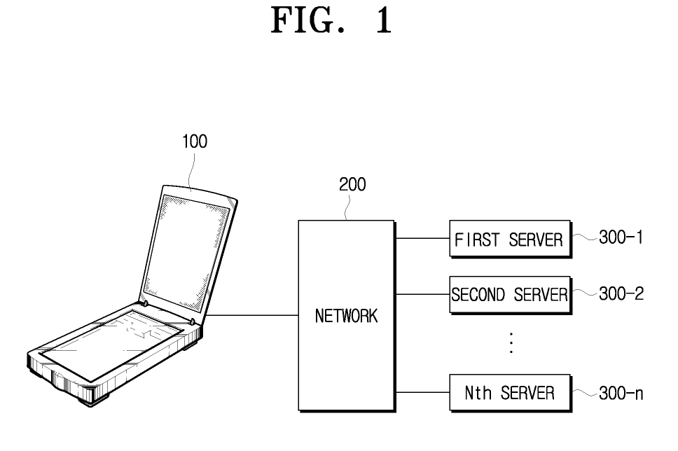

FIG. 1 shows the configuration of a data transmission system according to an embodiment of the present general inventive concept. In FIG. 1, the data transmission system includes an image forming device 100, a network 200, and a plurality of servers 300-1, 300-2, . . . 300-n.

The image forming device 100 transmits scanned image data to a certain server through the network 200. More specifically, when transmitting the scanned image data to the server, a user selects at least one server among the plurality of servers 300-1, 300-2, . . . , 300-n connected to each other through the network 200. If the set (selected) server is a server having a history of data transmission errors, the image forming device 100 displays a message to report the history of data transmission errors to the user. Additionally, the image forming device 100 confirms whether or not to adjust the transmission rate and then transmits the image data after adjusting the transmission rate based on the user's confirmation.

Alternatively, if the selected server is a server that does not have any history of a data transmission error, the image forming device 100 transmits the image data to the server. In this situation, the server transmits the result of image data transmission to the image forming device 100.

If the image forming device 100 receives a transmission error occurrence signal from the servers 300-1, 300-2, . . . , 300-n, the image forming device 100 displays a message reporting to the user the occurrence of the data transmission error. The image forming device 100 also requests and confirms adjustment of the transmission rate and retransmits the image data after adjusting the transmission rate based on the adjustment and confirmation. If the image forming device 100 receives the transmission error occurrence signal from the server, the image forming device 100 stores identity of the server in a list to manage the server when transmitting data next time.

Consequently, more stable data transmission is guaranteed by adjusting the transmission rate and data transmission errors are reduced by managing the servers where one or more transmission errors occur or have occurred.

FIG. 2 is a block diagram illustrating an image forming device according to an embodiment of the present general inventive concept. In FIG. 2, the image forming device 100 includes a scanning part 110, a user interface 120, a storage unit 130, a controller 140, a data transmitter 150, a message generator 160 and a display 170.

The scanning part 110 scans a document or an image to generate image data corresponding to the scanned document or image.

The user interface 120 sets (selects) a server to transmit the image data scanned by the scanning part 110 and sets the data transmission rate. The server and data transmission rate can be set by a user.

The storage unit 130, such as a memory device, stores a list of servers having a history of data transmission error. The history may include a server identity, the number of occurrence of the data transmission errors, and/or transmission rates in which the data transmission errors occur.

The data transmitter 150 transmits the scanned image data to a server. The data transmitter 150 may use one of Hypertext Transfer Protocol (HTTP), File Transfer Protocol (FTP), Server Message Block (SMB), Secure Hypertext Transfer Protocol (HTTPS) and Simple Mail Transfer Protocol (SMTP).

The message generator 160 generates a message regarding the data transmission.

The display 170 displays the message generated by the message generator 160.

The controller 140 controls the overall operation of the image forming device 100. More specifically, if a server set through the user interface 120 is included in the list stored in the storage 130, the controller 140 operates the message generator 160 and the display 170 to generate and display a message indicating that the server has a history of a transmission error. In this case, the message includes user input and confirmation of whether or not to adjust the transmission rate. Adjusting the transmission rate may be accomplished by adjusting the transmission time between one packet of the image data and a next packet. If a transmission time between one packet of the image data and a next packet is adjusted, the average data transmission rate is adjusted. If the data transmission rate is adjusted through the user interface 120 in this manner, the controller 140 operates or controls the data transmitter 150 to transmit the image data at the adjusted transmission rate. In more detail, if the adjusted transmission time interval between packets has expired after one packet of the image data is transmitted, then the next packet is transmitted. In this manner, the overall or average data transmission rate can be adjusted.

Meanwhile, if a server selected through the user interface 120 is not included in the list in the storage 130, the controller 140 operates the data transmitter 150 to transmit the image data at the preset transmission rate. But if transmission errors, such as time-out errors, occur when transmitting the image data at the preset transmission rate, the controller 140 operates the storage 130 to add the erroneous server to the list in storage 130. Additionally, the controller 140 operates the message generator 160 and the display 170 to generate and display a message reporting the occurrence of the data transmission error. If the data transmission rate is adjusted, the controller 140 operates the data transmitter 150 to transmit the image data at the adjusted transmission rate.

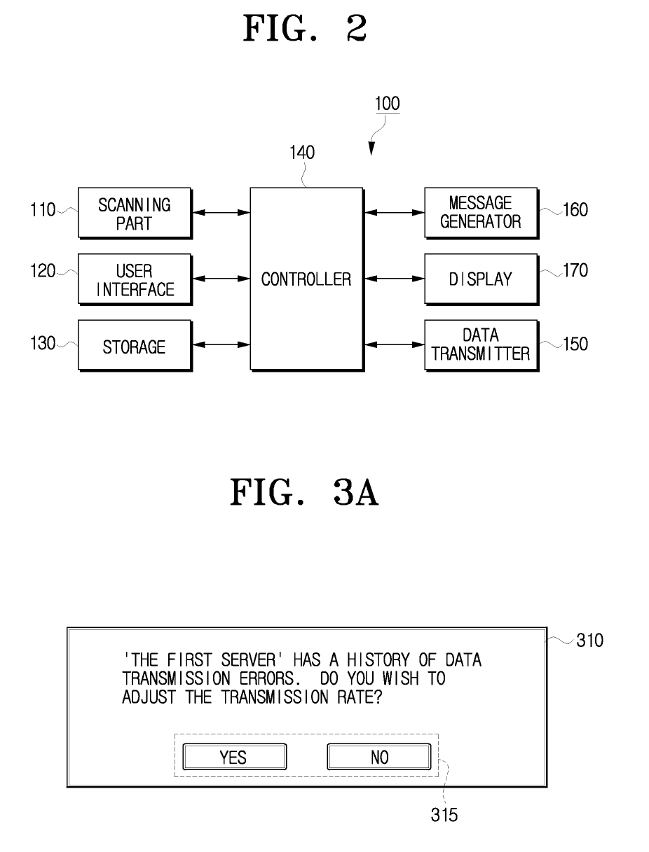

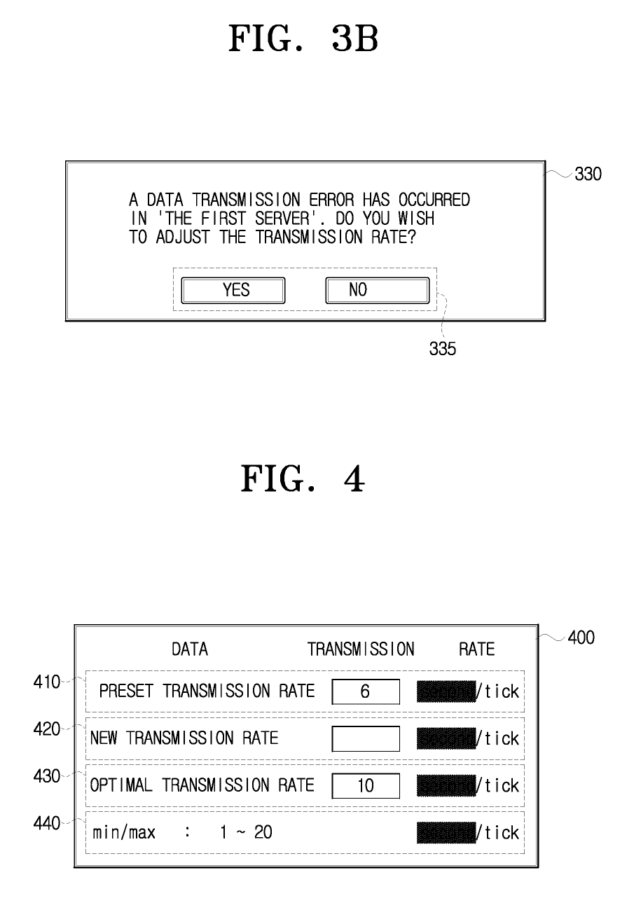

FIGS. 3A and 3B illustrate exemplary message windows 310 and 330 regarding data transmission. Referring to FIGS. 2 and 3A, the message window 310 is displayed if the server selected by the user has a history of transmission errors which may be stored in the storage unit 130. More specifically, the message window 310 includes a message indicating that this server has a history of transmission errors, and a sub-message confirming or asking whether to adjust the transmission rate. For example, if the user has selected a first server as a server for data transmission through the user interface, and the first server is included in the list of servers having a history of transmission errors, the message window 310 displays (for example) the message “The first server has a history of transmission errors” and the user is made aware that the first server has a history of transmission errors. Additionally, the message window 310 may include a selection field 315 to select whether or not to adjust the data transmission rate in order to transmit data to the first server. The user can adjust the data transmission rate if necessary.

Referring to FIGS. 2 and 3B, the message window 330 is displayed if an error occurs while transmitting the image data. The exemplary illustrated message window 330 includes a message reporting the occurrence of the transmission error, and a message the user to choose whether or not to adjust the transmission rate. For example, when the image forming device 100 transmits image data to the first server and a transmission error occurs, the message window 330 may display the message “There is a transmission error in the first server”. Accordingly, the user is made aware that there is an error in the data transmission. The message window 330 may include a selection field 335 for the user to select whether to adjust the data transmission rate for transmitting data to the first server.

FIG. 4 illustrates a window 400 to adjust the data transmission rate. The data transmission rate adjusting window 400 is displayed if ‘yes’ is selected in either one of the selection fields 315 and 335 of the message windows 310 and 330 shown in FIGS. 3A and 3B, respectively. The data transmission rate adjusting window 400 includes several fields for adjusting transmission rates. The first field is a field 410 initially showing the preset transmission rate and also allowing for adjustment of this preset transmission rate. In field 410, the user can adjust the preset transmission rate by inputting a rate greater than the previous preset transmission rate, for example, by tapping on the black rectangle to the right of the rectangle displaying the numeral “6” in FIG. 4. The data transmission rate adjusting window 400 also includes a second field 420 in which the user can input a new data transmission rate without changing the preset rate. The transmission rate unit may be based on a ‘second’ or a ‘tick’. In FIG. 4, the unit of the transmission rate is exemplified as a ‘tick’.

The data transmission rate adjusting window 400 also includes a third field 430 showing an optimal transmission rate. The optimal transmission rate can be the data receiving rate or data processing rate of the server. The data receiving rate or data processing rate can be included in a signal from the server that reports the occurrence of a transmission error. The data transmission rate adjusting window 400 also includes a fourth field 440 showing the minimum and maximum rates as input by the user at the bottom. Accordingly, the user can input a new transmission rate in the second field 420 based on the preset transmission rate, the optimal transmission rate and the minimum and maximum rates in the data transmission rate adjusting window 400. For example, as illustrated in FIG. 4, the user can input a value greater than 6 in field 410, and a value equal to or greater than 10 in field 430. In this example, the new transmission rate can be a value of 10 to 20, the maximum rate. Assuming that 10 is the new transmission rate, then 10 ticks will pass after transmitting one packet, before the next packet is transmitted. In this manner, the average transmission rate is adjusted. Accordingly, the data can be more stably transmitted, compared to the preset transmission rate in which the transmission interval between packets is 6 ticks.

This way, if the new transmission rate is input, that new transmission rate is applied by the packet so that the data is transmitted. Therefore, transmission errors can be reduced by adjusting the data transmission rate.

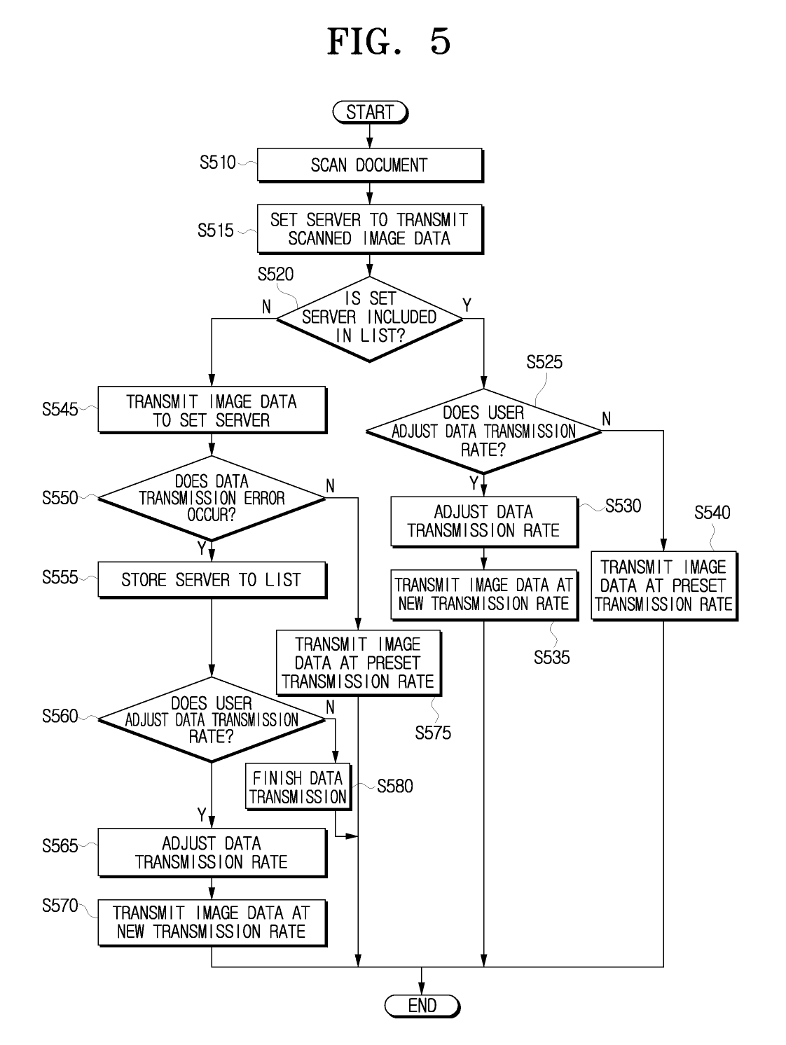

FIG. 5 is a flow chart illustrating a data transmission method of an image forming device according to an exemplary embodiment of the general inventive concept. With reference to FIG. 5 (and the other figures of the drawing), the image forming device 100 scans a document (S510), and selects a server to transmit the scanned image data using the user interface 120 (S515). The server may be one of a plurality of servers 300-1, 300-2, . . . . 300-n connected to the network.

Subsequently, the image forming device 100 confirms whether the server selected in the operation S515 is included in a list of servers having a history of transmission errors (S520). The list may be in storage 130, for example. If the server is included in the list, the image forming device 100 confirms whether to adjust the data transmission rate (S525). (Operations S520 and S525 are illustrated in FIG. 3A also. If the data transmission rate is to be adjusted, the image forming device 100 displays a message such as that of FIG. 3A reporting the existence of a history of data transmission errors. The user can select whether to adjust the data transmission rate. If the scanned image data is color data, high definition data, or a large quantity of data, the data transmission rate can be adjusted. However, if the scanned image data is black and white data or a small quantity of data, the probability of errors occurring due to the data transmission rate is low, and accordingly the data can be transmitted without adjusting the data transmission rate.

If the user confirms that the image forming device 100 is to adjust the data transmission rate in the operation of S525, the data transmission rate is adjusted to the new data transmission rate (S530 and FIG. 4). In this case, the user can directly input the new data transmission rate into the data transmission rate adjusting window 400. The preset transmission rate, optimal transmission rate, and the minimum and maximum rates are displayed on the data transmission rate adjusting window 400, so the user can input the new data transmission rate based on the displayed transmission rates. Accordingly, the image forming device 100 can transmit the image data to the corresponding server at the new transmission rate (S535). More specifically, if a transmission time between data packets has elapsed after one packet of the image data has been transmitted, then the next packet is transmitted. In this manner, the transmission rate of the entire data (the average data rate) can be adjusted.

If the user instructs the image forming device 100 not to adjust the data transmission rate in the operation S525, the image data is transmitted to the corresponding server at the preset data transmission rate (S540).

If a selected server is not included in a list in the operation of S520, the image data is transmitted to the set server at the preset transmission rate (S545). Subsequently, if data transmission errors such as time-out errors occur when transmitting the image data (S550), the corresponding server is added to the list of servers with a history of data errors (S555). In this case, the image forming device 100 displays a message reporting the occurrence of a data transmission error (e.g., FIG. 3B).

On the other hand, if a data transmission error does not occur when transmitting the image data (S550), the image forming device 100 transmits the entire image data at the preset transmission rate (S575).

Returning to the case of a transmission error occurring, the image forming device 100 subsequently asks the user to confirm whether to adjust the data transmission rate using a display window (S560 and FIG. 3B). If the user confirms to adjust the data transmission rate, the data transmission rate is adjusted by the image forming device (S565) and the image data is transmitted at a new transmission rate (S570). However, if there is no confirmation to adjust the data transmission rate, the data transmission is finished (S580).

The present general inventive concept can also be embodied as computer-readable codes as a program on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

Consequently, more stable data transmission is guaranteed by adjusting a transmission time between data packets and consequently adjusting the data transmission rate of the entire data when transmitting data, and data transmission errors are reduced by managing the servers where transmission errors occur. Users can confirm data transmission information by displaying the data transmission errors.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming device to scan a document, the device comprising:
a data transmitter to transmit scanned image data to a server; and
a controller to operate the data transmitter to adjust a transmission rate of the image data according to a characteristic of the server.

2. The image forming device of claim 1, further comprising:
a storage unit which stores a list of servers having a history of occurrence of data transmission errors as characteristics of the servers,
wherein:
the controller confirms whether the server to which the image data is transmitted is included in the list;
the controller adjusts the transmission rate of the image data if the server is included in the list; and
the controller operates the data transmitter to transmit the image data at a preset transmission rate if the server is not included in the list.

3. The image forming device of claim 2, further comprising:
a user interface to adjust the transmission rate of the data,
wherein the controller operates the data transmitter to transmit the image data at a transmission rate adjusted at the user interface if the server is included in the list.

4. The image forming device of claim 2, further comprising:
a message generator to generate a message to report that the server is included in the list if the server is included in the list; and
a display to display the message.

5. The image forming device of claim 4, wherein if the server is included in the list, the controller operates the message generator and the display to generate and display a second message including the preset transmission rate, an optimal transmission rate for the server, and minimum and maximum transmission rates able to be input.

6. The image forming device of claim 4, wherein if a data transmission error occurs when transmitting the image data at the preset transmission rate, the controller operates the message generator and the display to generate and display a third message to report the error occurrence to a user.

7. The image forming device of claim 2, wherein if a data transmission error occurs when transmitting the image data at the preset transmission rate, the controller adds the server to the list.

8. The image forming device of claim 1, wherein the data transmitter transmits the image data using one of Hypertext Transfer Protocol (HTTP), File Transfer Protocol (FTP), Server Message Block (SMB), Secure Hypertext Transfer Protocol (HTTPS) and Simple Mail Transfer Protocol (SMTP).

9. The image forming device of claim 1, wherein the server to which the image data is transmitted is one server belonging to a plurality of servers connected to the network.

10. A data transmission method of an image forming device which scans a document, the method comprising:
scanning a document and generating image data; and
transmitting the image data to a server by adjusting a transmission rate of the image data corresponding to the server to which the image data is transmitted.

11. The method of claim 10, wherein the transmitting of the image data comprises:
confirming whether the server is included in a list of servers having a history of one or more data transmission errors; and
adjusting the transmission rate of the image data if the server is included in the list, and transmitting the image data at a preset transmission rate if the server is not included in the list.

12. The method of claim 11, further comprising:
generating and displaying a message to report an error occurrence if a data transmission error occurs when transmitting the image data at the preset transmission rate.

13. The method of claim 11, further comprising:
adding the server to the list, if a data transmission error occurs when transmitting the image data at the preset transmission rate.

14. The method of claim 11, wherein the transmitting of the image data comprises:
providing an user interface to adjust the transmission rate of the image data if the server is included in the list; and
transmitting the image data at a new transmission rate adjusted through the user interface.

15. The method of claim 14, wherein the user interface displays the preset transmission rate, an optimal transmission rate for the server, and minimum and maximum transmission rates able to be input.

16. The method of claim 11, further comprising:
generating a message to report that the server is included in the list and
displaying the message if the server is included in the list.

17. The method of claim 10, wherein the transmitting of the image comprises transmitting the image data using one of Hypertext Transfer Protocol (HTTP), File Transfer Protocol (FTP), Server Message Block (SMB), Secure Hypertext Transfer Protocol (HTTPS) and Simple Mail Transfer Protocol (SMTP).

18. The method of claim 10, wherein the server to which the image data is transmitted belongs to a plurality of servers connected to the network.

19. An image forming device to scan a document, the device comprising:
a data transmitter to transmit scanned image data to a selected server;
a storage unit to store a list of servers having a history of one or more data transmission errors; and
a controller to operate the data transmitter to adjust a transmission rate of the image data corresponding to the server if the selected server is included in the list.

20. The image forming device of claim 19, further comprising:
a display;
a message generator to generate a message on the display; and
a user interface to adjust the transmission rate of the image data,
wherein, if the selected server is included in the list, the controller operates the message generator and the display to generate and display a message to report a possibility of occurrence of a data transmission error when transmitting the image data, and to operate the data transmitter to transmit the image data at the transmission rate adjusted by the user interface.

21. An image forming device to scan a document, the device comprising:
a storage unit to store a list of servers having a history of one or more data transmission errors; and
a controller to adjust a transmission rate of the image data according to a selected server if the selected server is included in the list.

22. An image forming device comprising:
a data transmitter to transmit image data to a selected server; and
a controller to adjust a transmission rate according to a history of occurrence of one or more data transmission error of the selected server.

23. An image forming device comprising:
a storage unit to store information on a data transmission error of a server;
a data transmitter to transmit data at a transmission rate to another server, and to transmit the data at an adjusted transmission rate to the server according to the information.

24. An image forming device comprising:
a storage unit to store information on a data transmission error of a server; and
a data transmitter to transmit a first packet of data to the server at a first adjusted transmission rate and a second packet of the data at a second adjusted transmission rate to the server according to the information.

25. A method of transmitting data at a data transmission rate to a server having a maximum data acceptance rate in a data transmission system, the method comprising:
storing a list of error-prone servers in a storage unit; and
adjusting a data transmission rate of scanned image data to be sent a server if the server is on the list.

26. A computer readable recording medium containing computer readable codes as a program to execute a method of transmitting data to a server, the method comprising:
scanning a document and generating image data; and
transmitting the image data to a server by adjusting a transmission rate of the image data corresponding to the server to which the image data is transmitted.
